(19) United States
(12) Patent Application Publication
(10) Pub. No.: US 2021/0240807 A1
(43) Pub. Date: Aug. 5, 2021

(54) AUTHENTICATION METHOD FOR MOBILE TERMINAL AND MOBILE TERMINAL

(71) Applicant: HUAWEI TECHNOLOGIES CO., LTD., Shenzhen, Guangdong (CN)

(72) Inventors: Chan WANG, Shenzhen (CN); Huangwei WU, Shenzhen (CN)

(21) Appl. No.: 16/314,031

(22) PCT Filed: Jun. 30, 2016
(86) PCT No.: PCT/CN2016/087993

§ 371 Date: Dec. 28, 2018

(51) Int. Cl. G06F 21/32; G06Q 20/40

(52) U.S. Cl. CPC G06F 21/32; G06Q 20/40145

(57) ABSTRACT

The present disclosure relates to authentication methods for a mobile terminal. One example method includes running, by a first application, in a first execution environment, running, by a second application, in a second execution environment, the second application associated with the first application, running, by a biometric feature management module, in the second execution environment, generating, by the first application, a first request message, and receiving, by the second application, the first request message by using interfaces of the first execution environment and the second execution environment. If the second application determines that the first request message is a request message related to a biometric feature, the second application sends the first request message to the biometric feature management module.

### TECHNICAL FIELD

Embodiments of the present invention relate to the field of communications technologies, and in particular, to an authentication method for a mobile terminal and a mobile terminal.

### BACKGROUND

With development of the mobile Internet, intelligent terminals are increasingly popular, and become indispensable in people's daily work and life. As user equipment becomes intelligent and diversified, user privacy protection of an intelligent terminal attracts increasing attention. For some applications and content, the intelligent terminal provides a user identity authentication mechanism. For example, the intelligent terminal requires a user to enter fingerprint information for identity authentication before running the applications or presenting the content, and runs the applications or presents the content only after identity authentication succeeds. On this basis, to further ensure identity authentication security, a concept of a trusted execution environment (Trusted Execution Environment, TEE) is further proposed in the industry to distinguish from a rich execution environment (Rich Execution Environment, REE) such as conventional Android and IOS.

In the prior art that includes the TEE, a process in which a user performs registration by using a fingerprint includes the following: A third-party client application in the REE sends a request message to a corresponding third-party trusted application in the trusted execution environment, and requests fingerprint registration, and after obtaining the request message, the third-party trusted application performs fingerprint registration by invoking a TEE Internal API. If multiple third-party client applications included in a mobile terminal need to perform fingerprint registration with a same function, each application sends a fingerprint registration request to a corresponding third-party trusted application in the TEE, and each third-party trusted application performs same fingerprint registration by invoking the TEE Internal API. Consequently, running resources of the mobile terminal are greatly consumed, and running efficiency of the mobile terminal is relatively low because of a repeated registration process.

### SUMMARY

Embodiments of the present invention provide an authentication method for a mobile terminal, an apparatus, and a mobile terminal, so as to resolve a prior-art technical problem that running resources are greatly consumed when the mobile terminal performs biometric feature authentication, and running efficiency of the mobile terminal is reduced.

According to a first aspect, an embodiment of the present invention provides an authentication method for a mobile terminal, where the method is applied to a mobile terminal, such as a mobile phone and a tablet computer.

In a first possible implementation, the method includes: running, by a first application, in an REE; running, by a second application, in a TEE, where the second application is associated with the first application; running, by a biometric feature management module, in the TEE, where the biometric feature management module is configured to perform, in the TEE, an operation related to biometric feature (for example, a fingerprint) authentication; generating, by the first application, a request message, where the request message carries identification information of the second application or the biometric feature management module; sending the request message to an interface of the TEE by using an interface of the REE; and if the request message carries the identification information of the second application, sending, by the interface of the TEE, the request message to the second application; or if the request message carries the identification information of the biometric feature management module, sending, by the interface of the TEE, the request message to the biometric feature management module. In this method, based on an original biometric feature authentication architecture, the biometric feature management module is added to centrally manage biometric feature authentication, that is, biometric feature authentication operations of all applications in the REE environment are centrally processed by the biometric feature management module, thereby improving biometric feature authentication efficiency.

With reference to the first possible implementation of the first aspect, in a second possible implementation, the biometric feature management module sends a response message by following an original path, where the response message is a response to the request message, that is, the biometric feature management module generates the response message; the response message is sent to the interface of the REE by using the interface of the TEE; and the interface of the REE sends the response message to the first application, so that the return path ensures that the first application obtains a biometric feature authentication result in time.

With reference to the second possible implementation of the first aspect, in a third possible implementation, the request message is used to request to authenticate a biometric feature (for example, verify a fingerprint). A process in which the biometric feature management module generates the response message is specifically: invoking a biometric feature interface, where the biometric feature interface invokes hardware of the mobile terminal to obtain a to-be-authenticated biometric feature; obtaining, by the hardware of the mobile terminal, a biometric feature stored in the mobile terminal; determining, by the hardware of the mobile terminal, whether the to-be-authenticated biometric feature matches the biometric feature stored in the mobile terminal, and generating an authentication result; and receiving, by the biometric feature management module, the authentication result sent by the hardware of the mobile terminal by using the biometric feature interface, and generating the response message.

With reference to the second possible implementation of the first aspect, in a fourth possible implementation, the request message carries type information of the first application (for example, a payment-type application), and the request message is used to request to authenticate a biometric feature (for example, verify a fingerprint). A process in which the biometric feature management module generates the response message is specifically: invoking, by the biometric feature management module by using a biometric feature interface, hardware of the mobile terminal to obtain a to-be-authenticated biometric feature; obtaining, by the hardware of the mobile terminal, at least one first biometric feature stored in the mobile terminal, where type information of the first biometric feature matches the type information of the first application, that is, the mobile terminal stores type information corresponding to the biometric feature, for example, a payment-type fingerprint is used for a payment-type application, and a shortcut-type fingerprint is used to quickly open an application; and if the hardware of the mobile terminal determines that the to-be-authenticated biometric feature matches the first biometric feature, receiving, by the biometric feature management module, an authentication result sent by the hardware of the mobile terminal by using the biometric feature interface, and generating the response message. In the method embodiment, the mobile terminal may invoke a corresponding biometric feature in a specific type according to the type information of the first application, so that authentication can be implemented without traversing all biometric features stored in a mobile phone, thereby improving authentication efficiency.

With reference to the fourth possible implementation of the first aspect, in a fifth possible implementation, the method further includes: if the hardware of the mobile terminal determines that the to-be-authenticated biometric feature does not match the first biometric feature, traversing, by the hardware of the mobile terminal, all biometric features to attempt to authenticate the to-be-authenticated biometric feature; generating an authentication result, and sending the authentication result to the biometric feature interface; and then obtaining, by the biometric feature management module, the authentication result, and generating the response message. In the method embodiment, as a supplement to the previous possible implementation solution, when the mobile terminal finds no biometric feature of a same type as the first application, the mobile terminal traverses all biometric features of the mobile terminal to perform authentication, so as to ensure authentication result output.

Adaptively, based on the method described in the first aspect, an embodiment of the present invention further provides an apparatus and a mobile terminal that are configured to perform the method. For a specific system architecture, refer to FIG. 4 or FIG. 5, and specific details thereof are described in the following specific embodiments. The apparatus or the mobile terminal can improve biometric feature authentication efficiency.

According to a second aspect, an embodiment of the present invention provides an authentication method for a mobile terminal, where the method is also applied to a mobile terminal, such as a mobile phone and a tablet computer.

In a first possible implementation, the method includes: running, by a first application, in an REE; running, by a second application, in a TEE, where the second application is associated with the first application; running, by a biometric feature management module, in the TEE; generating, by the first application, a first request message; receiving, by the second application, the first request message by using interfaces of the REE and the TEE; and if the second application determines that the first request message is a request message related to a biometric feature, sending, by the second application, the first request message to the biometric feature management module. In this embodiment of the present invention, based on an original biometric feature authentication structure, the biometric feature management module is added to manage biometric feature authentication, that is, all applications in the REE environment first send a message to an associated application in the TEE environment, and if the message is a message related to biometric feature authentication, the application in the TEE environment sends the authentication request to the biometric feature management module for centralized processing, thereby improving biometric feature authentication efficiency.

With reference to the first possible implementation of the second aspect, in a second possible implementation, the method further includes: running, by a third application, in the REE environment; running, by a fourth application, in the TEE environment, where the fourth application is associated with the third application; generating, by the third application, a second request message; receiving, by the fourth application, the second request message by using the interfaces of the first execution environment and the second execution environment; and if the fourth application determines that the second request message is a request message related to a biometric feature, sending, by the fourth application, the second request message to the biometric feature management module. In this embodiment of the present invention, multiple applications in the REE environment send a request message to an associated application in the TEE environment, and the associated application determines whether the associated application processes the request message or to send the request message to the biometric feature management module for processing.

With reference to the first or the second possible implementation of the second aspect, in a third possible implementation, the biometric feature management module generates a first response message, where the first response message is a response made by the biometric feature management module to the first request message; the second application receives the first response message sent by the biometric feature management module; and the first application receives the first response message by using the interfaces of the REE environment and the TEE environment, so that the return path ensures that the first application obtains a biometric feature authentication result in time.

With reference to the third possible implementation of the second aspect, in a fourth possible implementation, the first request message is used to request to authenticate a biometric feature; and the generating, by the biometric feature management module, a first response message includes: invoking, by a biometric feature interface, hardware of the mobile terminal to obtain a to-be-authenticated biometric feature; obtaining, by the hardware of the mobile terminal, a biometric feature stored in the mobile terminal; determining, by the hardware of the mobile terminal, whether the to-be-authenticated biometric feature matches the biometric feature stored in the mobile terminal, and generating an authentication result; and receiving, by the biometric feature management module, the authentication result sent by the hardware of the mobile terminal by using the biometric feature interface, and generating the first response message.

With reference to the third possible implementation of the second aspect, in a fifth possible implementation, the first request message carries type information of the first application (for example, a payment-type application); the request message is used to request to authenticate a biometric feature; and the generating, by the biometric feature management module, a first response message is specifically: invoking, by the biometric feature management module by using a biometric feature interface, hardware of the mobile terminal to obtain a to-be-authenticated biometric feature; obtaining, by the hardware of the mobile terminal, at least one first biometric feature stored in the mobile terminal, where type information of the first biometric feature matches the type information of the first application; and if the hardware of the mobile terminal determines that the to-be-authenticated biometric feature matches the first biometric feature, receiving, by the biometric feature management module, an authentication result sent by the hardware of the mobile terminal by using the biometric feature interface, and generating the first response message. In the method embodiment, the mobile terminal may invoke a corresponding biometric feature in a specific type according to the type information of the first application, so that authentication can be implemented without traversing all biometric features stored in a mobile phone, thereby improving authentication efficiency.

With reference to the fifth possible implementation of the second aspect, in a sixth possible implementation, the method further includes: if the hardware of the mobile terminal determines that the to-be-authenticated biometric feature does not match the first biometric feature, traversing, by the hardware of the mobile terminal, all biometric features to attempt to authenticate the to-be-authenticated biometric feature; generating, by the hardware of the mobile terminal, an authentication result, and sending the authentication result to the biometric feature interface; and receiving, by the biometric feature management module, the authentication result sent by the biometric feature interface, and generating the first response message. In the method embodiment, as a supplement to the previous possible implementation solution, when the mobile terminal finds no biometric feature of a same type as the first application, the mobile terminal traverses all biometric features of the mobile terminal to perform authentication, so as to ensure authentication result output.

Adaptively, based on the method described in the second aspect, an embodiment of the present invention further provides an apparatus and a mobile terminal that are configured to perform the method. For a specific system architecture, refer to FIG. 3, and specific details thereof are described in the following specific embodiments. The apparatus or the mobile terminal can improve biometric feature authentication efficiency.

In the embodiments of the present invention, the biometric feature management module is set, and the biometric feature management module is configured to perform an operation related to biometric feature authentication, thereby effectively saving running resources during biometric feature authentication, and improving authentication efficiency and running efficiency of the mobile terminal.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some but not all embodiments of the present invention. Persons of ordinary skill in the art may still derive other drawings from these accompanying drawings without creative efforts.

FIG. 1 is a schematic structural diagram of a mobile terminal according to an embodiment;

FIG. 2 is a diagram of a fingerprint identification architecture defined in a standard in the prior art;

FIG. 3 is a diagram of a fingerprint identification architecture according to an embodiment of the present invention;

FIG. 4 is a diagram of a fingerprint identification architecture according to an embodiment of the present invention;

FIG. 5 is a diagram of a fingerprint identification architecture according to an embodiment of the present invention;

FIG. 6 is a flowchart of a biometric feature authentication method according to an embodiment of the present invention;

FIG. 7 is a flowchart of a biometric feature authentication method according to an embodiment of the present invention;

FIG. 8 is a schematic diagram of a fingerprint authentication sequence according to an embodiment of the present invention; and

FIG. 9 is a schematic diagram of a fingerprint authentication sequence according to an embodiment of the present invention.

### DESCRIPTION OF EMBODIMENTS

To make the objectives, technical solutions, and advantages of the present invention clearer, the following further describes the embodiments of the present invention in detail with reference to the accompanying drawings. All other embodiments obtained by persons of ordinary skill in the art without creative efforts shall fall within the protection scope of the present invention. In specific descriptions of the following embodiments, related concepts are further explained based on a technical understanding of persons of ordinary skill in the art. It should be noted that these concepts constitute no limitation on explanations of a concept and a term well known in the technical field.

A mobile terminal, which may also be referred to as user equipment (User Equipment, UE) or an intelligent terminal, includes but is not limited to a mobile phone, a mobile computer, a tablet computer, a personal digital assistant (Personal Digital Assistant, PDA), a media player, a smart television, a smart watch, smart glasses, a smart band, and the like. In the present invention, a method for sharing a fingerprint template may be applied to various mobile terminals. The following describes a specific implementation performed by a mobile terminal that performs the method. In other implementations of the present invention, a well-known method, process, component, and circuit are not described in detail.

An operating system (Operating System, OS) is a computer program that manages computer hardware and software resources, and is a kernel and a cornerstone of a computer system. With development of mobile communications technologies, mobile terminal technologies have rapidly developed. A modern mobile terminal device provides a strong and flexible rich execution environment (Rich Execution Environment, REE), but the device is also vulnerable to a security threat. The REE refers to an operating system that has a strong processing capability and a multimedia function, such as Android and iOS.

A trusted execution environment (Trusted Execution Environment, TEE) is a technical solution proposed to resolve a problem of a security risk of a current mobile terminal device. The TEE is a trusted operating system that has a secure processing capability and provides a secure peripheral operation, and is mutually isolated from an REE on a same device and independently runs. The TEE is defined by GlobalPlatform (Global Platform), and is a secure area that resides on a main processor of a connected device, so as to ensure storage, processing, and protection of sensitive data in the trusted execution environment. The secure area is a logical concept and is used to represent a security attribute of the TEE. The TEE and the REE run on a same device in parallel, and a processor switches between the REE and the TEE according to an SMC instruction. The TEE can ensure that storage, processing, and protection of the sensitive data are performed in the trusted environment, provide a secure execution environment for authorized security software (for example, a trusted application), and implement end-to-end security by executing protection, confidentiality, integrity, and data access permission.

A secure element (Secure Element, SE), which is an electronic component that has a tamper-resistant function, may be installed on a terminal to provide a secure and confidential data storage and running environment for an application installed on the secure element. By extension of this, a hardware device that provides storage space used to install an application and has a management function for an installed application may be considered as a secure element. For example, a smartphone on which an Android system is installed may install third-party applications, and the Android operating system may manage these third-party applications and provide specific protection. Therefore, the smartphone may be considered as a secure element in a broad sense. The SE includes software and tamper-resistant hardware, supports high-level security, such as a SIM card, a financial IC card, and a smart SD card, and may run with the TEE together. Terms corresponding to the secure element in different specifications may be different. For example, in a series of GlobalPlatform specifications, this term SE (Secure Element) is defined and used. However, in a series of NFC Forum specifications, a term NFC execution environment NFCEE (NFC Execution Environment) is used instead of the SE. It should be noted that these two terms are equivalent in solutions of the embodiments of the present invention.

A trusted application (Trusted Application, TA) is an application that runs in the TEE, and may access all functions of a main processor and a memory of a device. A hardware isolation technology is used to protect the trusted application from being affected by application software installed in the REE. A client application (Client Applicatln, CA) runs in the REE, and the CA accesses the TA by invoking a TEE client application programming interface (Application Programming Interface, API) located in the REE, so as to use security functions provided by the TEE and the TA. An application developer usually provides a CA running in the REE environment and a TA running in the TEE environment when developing an application program, where the CA is in a one-to-one correspondence with the TA. For example, a developer develops installation files of two Alipay applications when developing the Alipay application. In the REE environment, a processor loads an installation file of an Alipay CA, and runs the Alipay CA; and in the TEE environment, the processor loads an installation file of an Alipay TA, and runs the Alipay TA.

A trusted user interface (Trusted User Interface, TUI) is an application interface of the TA, and is used to securely present a user interface to a user, so as to prevent an attack in a form such as phishing.

A biometric feature relying trusted application (Relying Trusted Application, RTA) is a concept defined in the draft standard “TEE Trusted User Interface API for Biometrics” published in December 2014, is a special TA, and is a TA that responds to a biometric feature verification result. In all TAs, a TA that requires biometric feature authentication may be an RTA. For example, the RTA responds to a fingerprint identification result in the TEE environment, and feeds back the responded result to the CA in the REE environment. Optionally, the RTA may be referred to as a fingerprint TA, or the like according to different specific biometric features.

A storage template (Stored Template) is also a concept (A Template created through Enrollment and stored with a unique identifier for use in future Identification and Verification) defined in the draft standard “TEE Trusted User Interface API for Biometrics” published in December 2014, is a template created in a biometric feature registration process, has a unique identifier, and is used for identification and verification in a use process. In the embodiments of the present invention, the storage template may be a registered biometric feature, that is, in some embodiments, a storage template of a biometric feature is equivalent to the biometric feature. For example, a fingerprint storage template may be equivalent to a fingerprint.

In the embodiments of the present invention, biometric feature authentication may be understood to include registration of a biometric feature, deletion of a biometric feature, verification of a biometric feature, cancellation of an association relationship between a biometric feature and an application, or the like, or may include another operation that may be related to a biometric feature. In the following description, only a fingerprint is used as an example of the biometric feature, and a specific implementation of the biometric feature may be an iris, a palm print, a face, or the like.

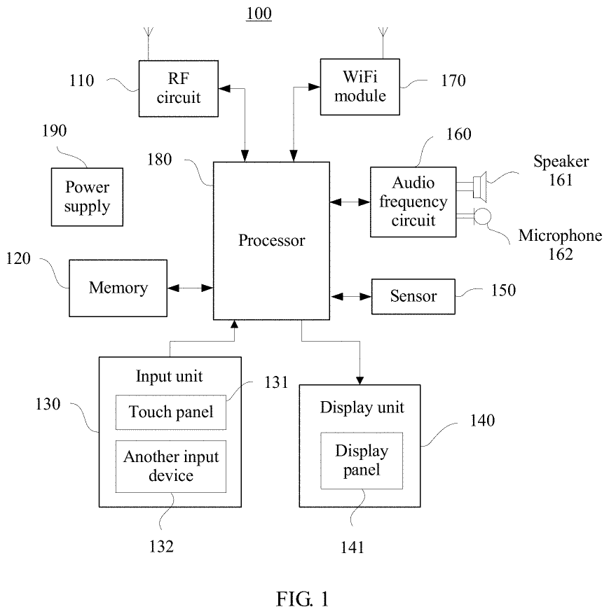

FIG. 1 is a schematic structural diagram of a mobile terminal according to an embodiment. It should be understood that a mobile terminal 100 shown in the figure is merely an example, and the actual product may have more or fewer parts than those shown in the figure, may combine two or more parts, or may have different part configurations. Various parts shown in the figure may be implemented in hardware that includes one or more signal processors and/or application-specific integrated circuits, in software, or in a combination of hardware and software. As shown in the figure, the mobile terminal 100 includes parts such as an RF (Radio Frequency, radio frequency) circuit 110, a memory 120, an input unit 130, a display unit 140, a sensor 150, an audio frequency circuit 160, a WiFi (wireless fidelity, Wireless Fidelity) module 170, a processor 180, and a power supply 190. The following describes each composition part in detail.

The RF circuit 110 may be configured to: receive and send a signal in an information receiving/transmitting process or a call process, and in particular, after receiving downlink information from a base station, send the downlink information to the processor 180 for processing; and in addition, send designed uplink data to the base station. Generally, the RF circuit includes but is not limited to an antenna, at least one amplifier, a transceiver, a coupler, an LNA (Low Noise Amplifier, low noise amplifier), a duplexer, and the like. In addition, the RF circuit 110 may communicate with a network and another device by means of wireless communications. The wireless communications may use any communications standard or protocol, including but not limited to GSM (Global System of Mobile communication, Global System for Mobile Communications), GPRS (General Packet Radio Service, general packet radio service), CDMA (Code Division Multiple Access, Code Division Multiple Access), WCDMA (Wideband Code Division Multiple Access, Wideband Code Division Multiple Access), LTE (Long Term Evolution, Long Term Evolution), an email, an SMS (Short Messaging Service, short message service), and the like.

The memory 120 may be configured to store a software program and a module, and the processor 180 performs various function applications of the mobile terminal 100 and data processing by running the software program and the module stored in the memory 120. The memory 120 may mainly include a program storage area and a data storage area. The program storage area may store an operating system, an application program required by at least one function (such as a sound playing function or an image playing function), and the like; and the data storage area may store data (such as audio data or an address book) created according to use of the mobile terminal 100, and the like. In addition, the memory 120 may include a high-speed random access memory, or may include a nonvolatile memory, such as at least one magnetic disk storage device, a flash device, or another volatile solid-state storage device.

The input unit 130 may be configured to: receive input number or character information, and generate key signal input related to user setting and function control of the mobile terminal 100. Specifically, the input unit 130 may include a touch panel 131 and another input device 132. The touch panel 131, also referred to as a touchscreen, may collect a touch operation (for example, an operation performed by a user on the touch panel 131 or near the touch panel 131 by using any proper object or accessory, such as a finger or a stylus) performed by the user on or near the touch panel 131, and drive a corresponding connection apparatus according to a preset program. Optionally, the touch panel 131 may include two parts: a touch detection apparatus and a touch controller. The touch detection apparatus detects a touch orientation of the user, and detects a signal brought by the touch operation, and sends the signal to the touch controller. The touch controller receives touch information from the touch detection apparatus, converts the touch information into contact coordinates, then sends the contact coordinates to the processor 180, and can receive and execute a command sent by the processor 180. In addition, the touch panel 131 may be implemented in multiple types, such as a resistive type, a capacitive type, infrared, and a surface acoustic wave. In addition to the touch panel 131, the input unit 130 may include the another input device 132. Specifically, the another input device 132 may include but is not limited to one or more of a physical keyboard, a function key (such as a volume control key or an on/off key), a trackball, a mouse, a joystick, or the like.

The display unit 140 may be configured to display information entered by the user or information provided for the user, and various menus of the mobile terminal 100. The display unit 140 may include a display panel 141. Optionally, the display panel 141 may be configured in a form, such as an LCD (Liquid Crystal Display, liquid crystal display) and an OLED (Organic Light-Emitting Diode, organic light-emitting diode). Further, the touch panel 131 may cover the display panel 141. After detecting the touch operation on or near the touch panel 131, the touch panel 131 sends the touch operation to the processor 180 to determine a type of a touch event, and then the processor 180 provides corresponding visual output on the display panel 141 according to the type of the touch event. In FIG. 1, the touch panel 131 and the display panel 141 serve as two independent parts to implement input and input functions of the mobile terminal 100; however, in some embodiments, the touch panel 131 and the display panel 141 may be integrated to implement the input and output functions of the mobile terminal 100.

The mobile terminal 100 may further include at least one sensor 150, such as a fingerprint sensor, a light sensor, a motion sensor, and another sensor. Specifically, the fingerprint sensor is configured to identify fingerprint information entered by the user. The light sensor may include an ambient light sensor and a proximity sensor. The ambient light sensor may adjust brightness of the display panel 141 according to luminance of ambient light, and the proximity sensor may disable the display panel 141 and/or backlight when the mobile terminal 100 approaches an ear. As a motion sensor, an accelerometer sensor may detect a value of acceleration in each direction (generally, three axes), may detect a value and a direction of gravity in a static state, and may be configured to identify an application of a mobile terminal posture (such as switching between a landscape and a portrait, a related game, and magnetometer posture calibration), a function related to vibration identification (such as a pedometer and a strike), and the like. Other sensors such as a gyroscope, a barometer, a hygrometer, a thermometer, and an infrared sensor may be further configured in the mobile terminal 100, and details are not described herein.

The audio frequency circuit 160, a speaker 161, and a microphone 162 may provide an audio interface between the user and the mobile terminal 100. The audio frequency circuit 160 may convert received audio data into an electrical signal, and transmit the electrical signal to the speaker 161, and the speaker 161 converts the electrical signal into a voice signal for output. In addition, the microphone 162 converts a collected voice signal into an electrical signal, and the audio frequency circuit 160 receives the electrical signal, converts the electrical signal into audio data, and outputs the audio data to the RF circuit 108, so as to send the audio data to, for example, another mobile terminal, or output the audio data to the memory 120 for further processing.

WiFi belongs to a short-range wireless transmission technology. The mobile terminal 100 may help, by using the WiFi module 170, the user receive and send emails, browse a web page, access streaming media, and the like. The WiFi module 170 provides the user with wireless broadband Internet access. Although FIG. 1 shows the WiFi module 170, it may be understood that the WiFi module 170 is not a mandatory component of the mobile terminal 100, and may be omitted according to a requirement without changing the essence scope of the present invention.

The processor 180 is a control center of the mobile terminal 100, and is connected to each part of the entire mobile terminal by using various interfaces and lines, and performs various functions of the mobile terminal 100 and data processing by running or executing the software program and/or the module that are/is stored in the memory 120 and invoking data stored in the memory 120, so as to perform overall monitoring on the mobile terminal. Optionally, the processor 180 may include one or more processing units. Preferably, the processor 180 may integrate an application processor and a modem processor. The application processor mainly processes an operating system, a user interface, an application program, and the like, and the modem processor mainly processes wireless communications. It may be understood that the modem processor may be not integrated into the processor 180.

The mobile terminal 100 further includes the power supply 190 (for example, a battery) that supplies power to each part. Preferably, the power supply may be logically connected to the processor 180 by using a power management system, so as to manage functions such as charging, discharging, and power consumption by using the power management system.

Although not shown in the figure, the mobile terminal 100 may further include a camera, a Bluetooth module, and the like, and details are not described herein.

GlobalPlatform is a cross-industry international standard organization, dedicated to developing, formulating, and publishing a technical standard for a secure chip, so as to facilitate management and secure and interoperable service deployment of a multi-application industry environment. GlobalPlatform mainly focuses on fields, such as a secure element (SE), a trusted execution environment (TEE), and system messaging (Mobile Messaging). The international standard organization formulates a set of standards for a TEE API and security service. A TEE security service example includes trusted storage, key management, encryption, a secure clock, a trusted user interface, and the like.

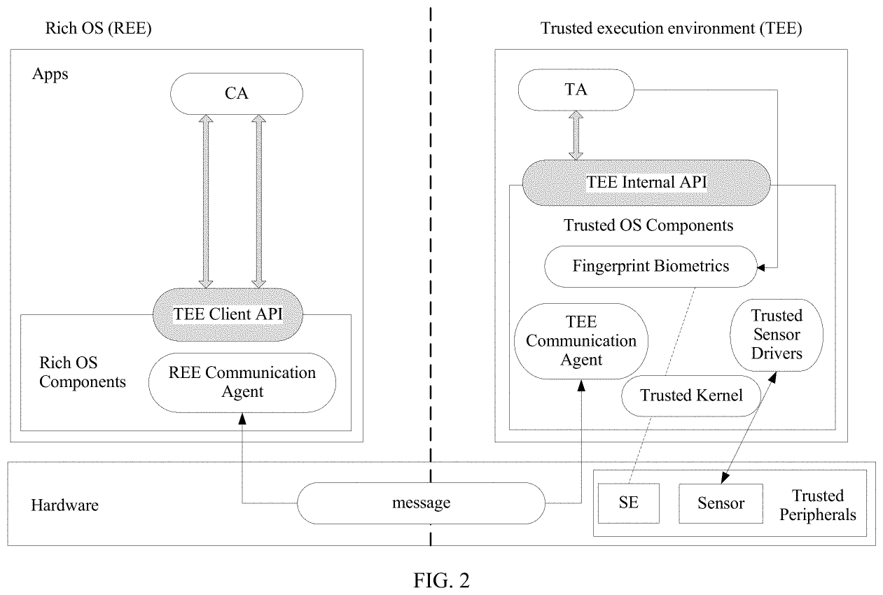

FIG. 2 is a diagram of a fingerprint identification architecture defined in a standard in the prior art. As shown in the figure, an interface between a TEE and an REE is referred to as a TEE Client API, and GlobalPlatform standardizes the TEE Client API in 2010. A CA runs in an REE environment, and the CA accesses the TEE by invoking the TEE Client API in the REE environment, so as to invoke the above-mentioned TEE security service example. Specifically, the TEE Client API includes an agent driver (REE Communication Agent). In the REE, the CA communicates with an agent driver (TEE Communication Agent) in the TEE by using the REE communication agent in the REE, so as to implement information exchange between the CA and a TA in the REE. The CA cannot directly access a resource of the TEE without using the REE communication agent. The TA runs in a TEE OS. The TEE can run multiple mutually independent TAs developed by different providers. The TA runs in the TEE and provides a security service for a CA corresponding to the TA. The TA may obtain controlled access to a security resource and a service in the TEE by invoking a TEE Internal API in the TEE. It should be noted that the Client API and the Internal API may be understood as API libraries, and the API libraries each actually includes multiple API interfaces. Fingerprint biometrics is an appendix to the Internal API, that is, the fingerprint biometrics may be understood as a part of an Internal API interface library. The fingerprint biometrics is equivalent to a fingerprint biometrics interface.

GlobalPlatform defines a TEE Internal API between a TA and a trusted operating system in 2011, and the TEE Internal API is used to provide a TA running in a TEE with an interface required to perform a TEE function. A higher-level standard and protocol layer may be established on the TEE Internal API, and a covered field includes confidential data management, payment, a financial service, digital rights management (Digital Rights Management, DRM), and the like.

The TEE Internal API includes three major types of components: (1) Trusted application TA; (2) Internal API library implementation: may include multiple interfaces, such as an enable session invoking interface and a disable session invoking interface; (3) Trusted OS component: used to provide a system-level function required by the TA, such as encryption and decryption, a certificate, and a signature. The trusted OS component notifies the TA of a change in a life cycle by using a series of entrypoint functions, and provides a communication relay with the CA. The TA invokes a function and a service of a trusted OS by using the TEE Internal API.

A trusted kernel is a real-time operating system that supports multitasking and is used for dynamic loading and running of the trusted application TA. The trusted kernel may implement security application memory isolation, and simultaneously provide a function, such as task processing, a communication function, and memory management.

A sensor (sensor) is a hardware apparatus in a mobile terminal, and is configured to read a biometric feature scanned by a user, for example, obtain fingerprint information entered by the user. The sensor transmits information by using a trusted sensor driver (Trusted Sensor Drivers), and an upper-layer application program operates or controls the sensor by using the trusted sensor drivers.

The trusted sensor drivers are a software driver module in the TEE environment, and the TEE provides the trusted sensor drivers with a secure running environment. The trusted sensor drivers are used to assist the sensor in implementing a function of the sensor, that is, implement the function of the sensor by providing a program interface that is used cooperatively with the sensor. The trusted sensor drivers define how the upper-layer application program enables or disables the sensor and how to control data transmission of the sensor. Functions provided by the trusted sensor drivers include: sending an initialization command of a fingerprint identification sensor, a command for requiring the fingerprint identification sensor to start to capture or stop capturing a fingerprint image, and inquiring whether a finger is on a surface of a capture device, or even driving the fingerprint identification sensor to determine whether a to-be-scanned object is a fingerprint. An existing fingerprint sensor includes a capacitive fingerprint identification sensor and a sliding fingerprint identification sensor. If the fingerprint identification sensor is a sliding fingerprint identification sensor, the trusted sensor drivers further include a command interface for fingerprint sequence reconstruction (splicing), and the like.

A fingerprint identification function is integrated into the TEE, and a fingerprint template registered by a user is securely stored in the TEE or an SE. The fingerprint biometrics provides a fingerprint identification function interface, for example, the fingerprint biometrics allows an RTA to verify a user identity, so as to access a fingerprint identification service in the TEE. Functions provided by the fingerprint biometrics include: a function 1, a function 2, a function 3, a function 4, a function 5, a function 6, and a function 7. The function 1 is to find the fingerprint identification function, and specifically includes the following: Any TA needs to be capable of finding any biometric identification function on a device, in particular, the fingerprint identification function. If there are multiple biometric identification services on user equipment, any TA should be capable of identifying and separately identifying them. The function 2 is to register a fingerprint, and specifically includes the following: A terminal user needs to be capable of registering at least one fingerprint as a biometric identification feature of the terminal user, and once registration is successful, one fingerprint template needs to be stored. A quality requirement of the fingerprint template is set, and if the registered fingerprint template does not meet a minimum quality standard, the registered fingerprint template is rejected. The terminal user may cancel a register operation in a registration process. Consequently, no template is created. An RTA unique identifier is returned for a created storage template by using a registration function, so as to allow an RTA to invoke the template. The function 3 is to verify the fingerprint, and specifically includes: performing matching between fingerprint information scanned by the user and one or more storage templates associated with the TEE that are in a mobile terminal, so that a user identity of the mobile terminal can be determined, or determining one mobile terminal user (finger) from a storage template list. A unique result needs to be returned by using a verification function, such as match or mismatch. The function 4 is to securely store the fingerprint registration template, and specifically includes the following: Any template created by means of registration needs to be securely stored in the TEE or securely stored in one SE. The function 5 is to associate the fingerprint, and specifically includes: a management function of increasing a quantity of an association between an RTA and a storage template, where the association should be a link between one RTA and one storage template. The function 6 is to remove the association with the fingerprint, and specifically includes: a management function of decreasing a quantity of an association between an RTA and a storage template, so as to remove an association between one RTA and one specific storage template. The function 7 is to delete the fingerprint template, for example, a management function of deleting one or more storage templates from the mobile terminal.

A procedure in which the user enters a fingerprint for identity authentication includes: The sensor transmits the fingerprint information to the SE after obtaining the fingerprint information, and the SE pre-processes the fingerprint information, where the pre-processing includes extracting a feature point, performing vectorization, generating a fingerprint image, and the like. The SE compares a pre-processed fingerprint image with a stored fingerprint template, and returns a verification result to a requested RTA by using the fingerprint biometrics. If a fingerprint verification result is that the fingerprint image entered by the user matches the stored fingerprint template, the RTA returns a verification success message to a CA in the REE environment by using the TEE communication agent to perform a corresponding function; or if a fingerprint verification result is that the fingerprint image entered by the user does not match the stored fingerprint template, the mobile terminal may present prompt information to prompt the user to re-enter a fingerprint for authentication.

In the diagram of the fingerprint identification architecture shown in FIG. 2, steps of accessing the TA by the CA include: (1) The CA invokes the TEE Client API in the REE environment, and creates a session with the TA. Information about the session created by the CA carries an identifier of the TA, for example, a universally unique identifier (Universally Unique Identifier, UUID) of the TA. A processor finds, in the TEE environment according to the UUID, a TA corresponding to the CA. (2) The CA initiates a command in the session, where the initiated command is transmitted to a TEE communication agent in the TEE environment by using the REE communication agent in the REE environment. Different application scenarios are corresponding to different command expression forms, and different functions are corresponding to different command expression forms. (3) The TA obtains, by using the TEE communication agent, the command initiated by the CA, and analyzes a message in the command. The command of the CA carries an identifier, for example, a universally unique identifier (Universally Unique Identifier, UUID) of the TA. The processor finds the TA according to the UUID, and the TA invokes the Internal API. (4) After obtaining the message in the command, the TA invokes the TEE Internal API to perform a corresponding operation, responds to a request of the CA, and establishes a corresponding task. The TEE communication agent sends an execution result to the REE communication agent, and the CA obtains a response message by using the REE communication agent. The TEE Client API and the TEE Internal API are concepts of two API libraries, and the two API libraries each include multiple API interfaces. The foregoing information exchange process is a process of constantly invoking interfaces in the two API libraries for instruction transmission.

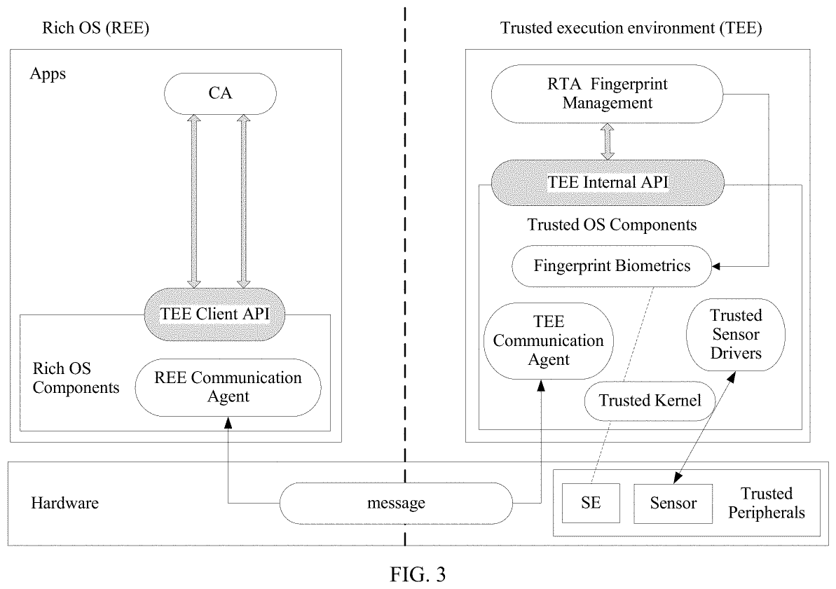

FIG. 3 is a diagram of a fingerprint identification architecture according to an embodiment of the present invention. FIG. 7 is a flowchart of a biometric feature authentication method according to an embodiment of the present invention. The fingerprint identification architecture in FIG. 3 may be used to perform the fingerprint authentication method shown in FIG. 7. As shown in FIG. 3 and FIG. 7, in this embodiment of the present invention, when a third-party CA initiates a fingerprint authentication-related operation such as fingerprint entering, fingerprint deletion, and fingerprint authentication by invoking a fingerprint authentication interface on an Android side, in addition to a TEE standard interface (that is, a TEE Internal API interface) (meeting a GlobalPlatform TEE API specification), a third-party TA corresponding to the third-party CA may invoke an interface provided by a fingerprint management TA (Trusted Application Fingerprint Management), so as to implement a fingerprint-related function, for example, perform fingerprint entering, delete fingerprint information that the user does not need, and return a fingerprint authentication result. The interface provided by the fingerprint management TA may exist, in multiple forms, in a TEE environment, for example, the interface may be an independent interface, or may be encapsulated in the TEE Internal API.

In an embodiment of the present invention, the mobile terminal provides a relying trusted application fingerprint management (Relying Trusted Application Fingerprint Management, RTA Fingerprint Management) module in the TEE environment. The RTA fingerprint management module is responsible for managing all fingerprints, and providing all third-party TAs with a service required for a fingerprint identification function, such as fingerprint entering, fingerprint deletion, and return of a fingerprint authentication result. It should be noted that, in this embodiment of the present invention, the relaying trusted application fingerprint management module is equivalent to a fingerprint management module, that is, the relaying trusted application fingerprint management module is one type of a biometric feature management module.

In this embodiment of the present invention, the CA invokes a TEE Client API in an REE environment, and creates a session with the TA. Information about the session created by the CA carries an identifier of the TA, for example, a universally unique identifier (Universally Unique Identifier, UUID) of the TA. A processor finds, in the TEE environment according to the UUID, a TA corresponding to the CA. The CA initiates a command in the session, and the initiated command is transmitted to the TA by using an REE communication agent in the REE environment and a TEE communication agent in the TEE environment. A processor or an internal processing mechanism in the TEE parses the command, obtains, by using the command, the TA corresponding to the CA, and sends the command to the TA. After obtaining the command, the TA parses the command and determines whether the command is related to fingerprint interaction. If the command is unrelated to fingerprint interaction, the TA invokes the TEE Internal API interface with reference to the above-mentioned TEE API specification of the GlobalPlatform standard, and performs a corresponding operation; or if the command is related to fingerprint interaction, or fingerprint authentication is required, the TA invokes an interface provided by an RTA fingerprint management module, and the RTA fingerprint management module centrally invokes a fingerprint identification function module (Fingerprint Biometrics), and runs an SE and a sensor on a hardware platform, so as to perform an operation related to fingerprint interaction. For a specific invoking procedure method for performing the interaction operation, and the like, refer to implementations of an existing standard and the prior art, and details are not described herein. When the RTA fingerprint management module completes the operation, and needs to transmit a fingerprint interaction result to the CA, the TA invokes the TEE Internal API interface, and transmits the interaction result to the CA by using the TEE communication agent in the TEE environment and the TEE Client API in the REE environment, for example, transmits encryption and decryption information, a signature, and the like to the CA. That is, in this embodiment of the present invention, one CA in the REE environment is corresponding to one TA in the TEE environment. After the CA sends a request message, if the request message is a request message unrelated to fingerprint interaction, the TA invokes the TEE Internal API; or if the request message is a request message related to fingerprint interaction, the TA invokes the fingerprint management module, and the fingerprint management module invokes a fingerprint function module, and processes the request message that is related to fingerprint interaction and that is initiated by the CA.

For example, an Alipay CA runs in Android, an Alipay TA runs in the TEE, and the RTA fingerprint management module runs in the TEE. The Alipay CA generates a fingerprint authentication request to request to verify whether a fingerprint entered by a current user matches a pre-stored fingerprint. The Alipay CA sends the fingerprint authentication request to the Alipay TA by using the REE communication agent in Android and the TEE communication agent in the TEE environment. The Alipay TA obtains the fingerprint authentication request, determines that the fingerprint authentication request is a fingerprint-related request message, and sends the fingerprint authentication request to the RTA fingerprint management module, and the RTA fingerprint management module processes the fingerprint authentication request. The RTA fingerprint management module invokes the fingerprint biometrics, and the fingerprint biometrics invokes the SE and the sensor on the hardware platform, so as to perform an operation related to fingerprint interaction, and generate an authentication result. After obtaining the authentication result, the RTA fingerprint management module returns the authentication result by using an original path, that is, the RTA fingerprint management module sends the fingerprint authentication result to the Alipay TA, and the Alipay TA sends the fingerprint authentication result to the Alipay CA by using the TEE communication agent and the REE communication agent.

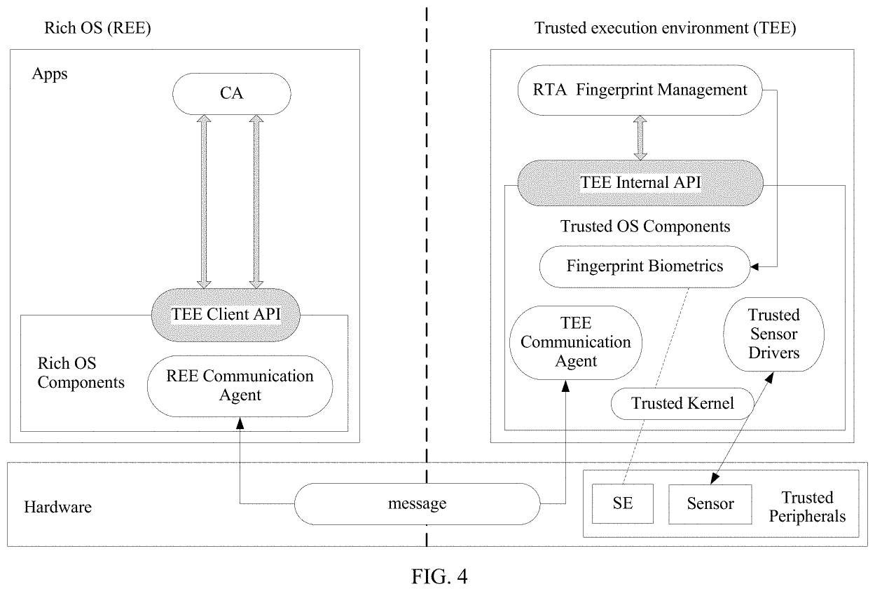

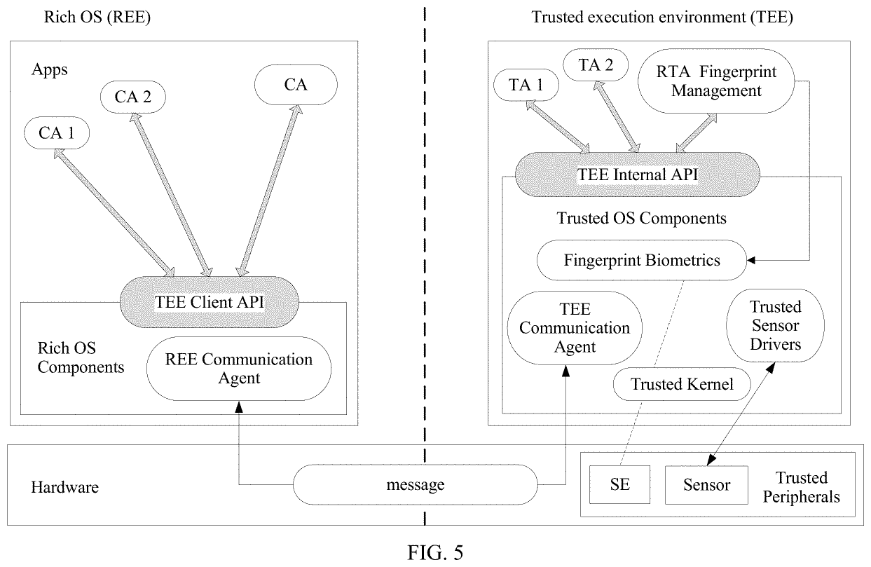

Specifically, in this embodiment of the present invention, a process in which the RTA fingerprint management module invokes hardware by using the fingerprint biometrics to perform authentication may have at least two implementation forms, and the hardware may include at least one of the SE or the sensor shown in FIG. 2, FIG. 3, FIG. 4, or FIG. 5. For example, in a possible implementation, the sensor obtains a fingerprint image entered by the current user, and the SE invokes a stored fingerprint and performs authentication.

First, the hardware of the mobile terminal traverses all fingerprints stored in the mobile terminal. If the hardware of the mobile terminal determines that a fingerprint matches a fingerprint carried in a fingerprint authentication request, the hardware of the mobile terminal determines that fingerprint authentication succeeds; or if the hardware of the mobile terminal determines that no fingerprint in all the fingerprints stored in the mobile terminal matches the fingerprint, the hardware of the mobile terminal determines that fingerprint authentication fails.

Second, the hardware of the mobile terminal may invoke a type of fingerprint stored in the mobile terminal, and then performs authentication. For example, the fingerprint authentication request carries type information of a CA. A fingerprint management module is responsible for managing all the fingerprints, and providing all third-party TAs with a service required for a fingerprint identification function. In this embodiment of the present invention, the fingerprint management module may further classify the fingerprints according to type information of an application program. The type information includes service type information and application type information. The service type information is used to represent attributes of various services included in an application. It may be understood that one application includes several services, that is, may include several types of service type information. In practice, one application may include multiple services. For example, service type information of a WeChat application may include a “social type” and a “payment type”. The former is corresponding to a WeChat chat function, and the latter is corresponding to a function, such as WeChat red packet and WeChat transfer. The application type information is used to represent an application type of the application, that is, a specific type to which the application may belong in use. For example, WeChat belongs to a “social type”, and Angry Birds belongs to a “game type”. During fingerprint authentication, the hardware of the mobile terminal may distinguish between the fingerprints according to the application type information. Fingerprint registration is used as an example. In the TEE environment, the TA may perform classification according to the application type information when sending a registration request to the fingerprint management module to request fingerprint registration. The CA may request to register a payment fingerprint when being a payment application such as Alipay or Industrial and Commercial Bank of China, where the payment fingerprint is used to perform fingerprint verification when the payment application runs. The CA may request to register a device unlocking fingerprint when being an application such as a screen locking application, where the device unlocking fingerprint is used to perform fingerprint verification when a user performs a terminal unlock operation. The CA may request to register an access control fingerprint when being an application such as Phone Manager, where the access control fingerprint is used to verify user permission when a specific user uses the terminal. The CA may request to register a file encryption fingerprint when being an application such as file management, where the file encryption fingerprint is used to provide fingerprint verification during file encryption. The following table shows some examples:

| Application name | Type information | Service type |
|---|---|---|
| CA 1 (Alipay) | Payment type | Payment |
| CA 2 (WeChat) | Payment type/social type | Payment/social |
| CA 3 (fingerprint unlock) | Security type | Device unlocking |
| CA 4 (Phone Manager) | Security type | Application |
| | | access control |
| CA 5 (file management) | Security type/ | File encryption |
| | efficiency type | |
| CA 6 | | |
| . . . | | |

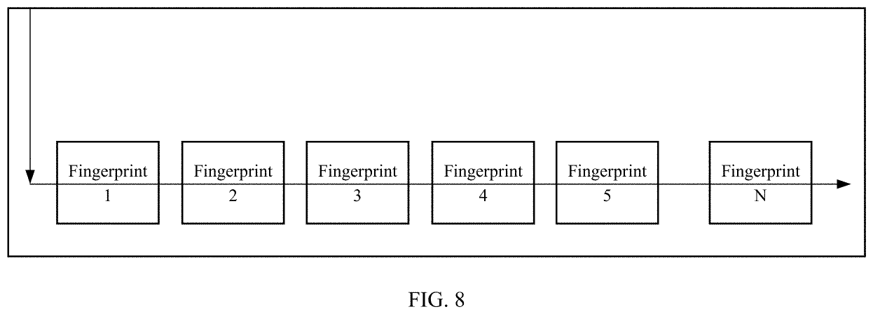

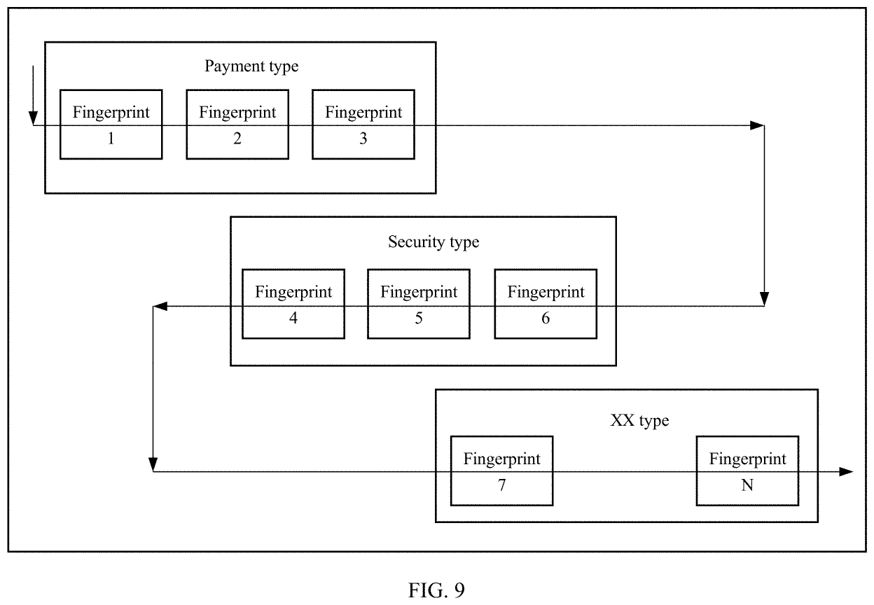

That is, the TEE may pre-store multiple biometric features, and the multiple biometric features are classified into different types according to different type information, such as a payment-type biometric feature and a security-type biometric feature. A common fingerprint authentication sequence is shown in FIG. 8. The mobile terminal traverses all the fingerprints stored in the mobile terminal, and determines whether there is a fingerprint that matches a to-be-authenticated fingerprint. In this embodiment of the present invention, the fingerprint authentication request sent by the Alipay CA carries type information of Alipay (that is, a payment-type application) and a to-be-authenticated fingerprint (a thumb fingerprint). The RTA fingerprint management module obtains type information of the Alipay CA, and invokes, from a payment-type fingerprint, a corresponding fingerprint for authentication if the type information of the Alipay CA is a payment type. If the thumb fingerprint is in the payment-type fingerprint, the RTA fingerprint management module determines that authentication succeeds, and returns an authentication result. Therefore, there is no need to traverse all fingerprints stored in a mobile phone, and only the payment-type fingerprint is invoked to implement authentication, thereby improving fingerprint authentication efficiency. That is, as shown in FIG. 9, a mobile terminal first determines a type of a CA, and then traverses fingerprints in the type of the CA. If the type of the CA is an Alipay CA, the mobile terminal traverses payment-type fingerprints, and determines whether there is a fingerprint that matches a to-be-authenticated fingerprint; and if there is no fingerprint that matches the to-be-authenticated fingerprint, the mobile terminal re-traverses fingerprints of a type similar to the type, such as a security type. If none of fingerprints matches the to-be-authenticated fingerprint, the mobile terminal traverses all fingerprints. In this way, authentication efficiency is improved. In a possible implementation, if the mobile terminal traverses payment-type fingerprints, and cannot determine whether authentication succeeds, the mobile terminal may traverse all fingerprints stored in the mobile terminal, and determines whether there is a fingerprint that matches a thumb fingerprint. If there is a fingerprint that matches the thumb fingerprint, the mobile terminal returns an authentication success result; or if there is no fingerprint that matches the thumb fingerprint, the mobile terminal returns an authentication failure result, thereby ensuring fingerprint authentication output. Likewise, during fingerprint registration, if the CA is Alipay, type information of the CA is a payment type, and a request message sent by the CA carries a thumb fingerprint, a fingerprint management module may set the thumb fingerprint as an authentication fingerprint of Alipay; or further, a fingerprint management module may set the thumb fingerprint as an authentication fingerprint of a payment-type application, for example, an authentication fingerprint of Industrial and Commercial Bank of China. Therefore, this improves fingerprint registration efficiency, and facilitates similar fingerprint management.

Likewise, referring to the foregoing execution procedures of the Alipay CA, the Alipay TA, and the RTA fingerprint management module, WeChat fingerprint authentication is also applicable, that is, a WeChat CA, a WeChat TA, and an RTA fingerprint management module may perform WeChat fingerprint authentication with reference to the foregoing procedures.

Adaptively, referring to the embodiment shown in FIG. 3 and the mobile terminal structure shown in FIG. 1, an embodiment of the present invention further provides a mobile terminal, and the mobile terminal may be configured to perform the method shown in FIG. 7. The mobile terminal includes: one or more processors, a memory, multiple application programs, and one or more programs, where the one or more programs are stored in the memory and executed by the one or more processors, the one or more programs include an instruction, and the instruction is used to perform the following operations: running, by a first application, in a first execution environment; running, by a second application, in a second execution environment, where the second application is associated with the first application; running, by a biometric feature management module, in the second execution environment; generating, by the first application, a first request message (701); receiving, by the second application, the first request message by using interfaces of the first execution environment and the second execution environment (702); and if the second application determines that the first request message is a request message related to a biometric feature, sending, by the second application, the first request message to the biometric feature management module (703).

Further, in this embodiment of the mobile terminal, the one or more processors execute the instruction to further perform the following operations: running, by a third application, in the first execution environment; running, by a fourth application, in the second execution environment, where the fourth application is associated with the third application; generating, by the third application, a second request message; receiving, by the fourth application, the second request message by using the interfaces of the first execution environment and the second execution environment; and if the fourth application determines that the second request message is a request message related to a biometric feature, sending, by the fourth application, the second request message to the biometric feature management module.

Based on the embodiment of the mobile terminal, in a possible implementation, the one or more processors execute the instruction to further perform the following operations: generating, by the biometric feature management module, a first response message, where the first response message is a response made by the biometric feature management module to the first request message; receiving, by the second application, the first response message sent by the biometric feature management module; and receiving, by the first application, the first response message by using the interfaces of the first execution environment and the second execution environment. Further, the first request message is used to request to authenticate a biometric feature; and the one or more processors execute the instruction to perform the following operations: the generating, by the biometric feature management module, a first response message includes: invoking, by the biometric feature management module by using a biometric feature interface, hardware of the mobile terminal to obtain a to-be-authenticated biometric feature; obtaining, by the hardware of the mobile terminal, a biometric feature stored in the mobile terminal; determining, by the hardware of the mobile terminal, whether the to-be-authenticated biometric feature matches the biometric feature stored in the mobile terminal, and generating an authentication result; and receiving, by the biometric feature management module, the authentication result sent by the hardware of the mobile terminal by using the biometric feature interface, and generating the first response message; or further, the first request message carries type information of the first application, and the request message is used to request to authenticate a biometric feature; and the one or more processors execute the instruction to perform the following operations: the generating, by the biometric feature management module, a first response message includes: invoking, by the biometric feature management module by using a biometric feature interface, hardware of the mobile terminal to obtain a to-be-authenticated biometric feature; obtaining, by the hardware of the mobile terminal, at least one first biometric feature stored in the mobile terminal, where type information of the first biometric feature matches the type information of the first application; and if the hardware of the mobile terminal determines that the to-be-authenticated biometric feature matches the first biometric feature, receiving, by the biometric feature management module, a first authentication result sent by the hardware of the mobile terminal by using the biometric feature interface, and generating the first response message. The one or more processors execute the instruction to further perform the following operations: if the hardware of the mobile terminal determines that the to-be-authenticated biometric feature does not match the first biometric feature, traversing, by the hardware of the mobile terminal, all biometric features to attempt to authenticate the to-be-authenticated biometric feature; generating, by the hardware of the mobile terminal, a second authentication result, and sending the second authentication result to the biometric feature interface; and receiving, by the biometric feature management module, the second authentication result sent by the biometric feature interface, and generating the first response message.

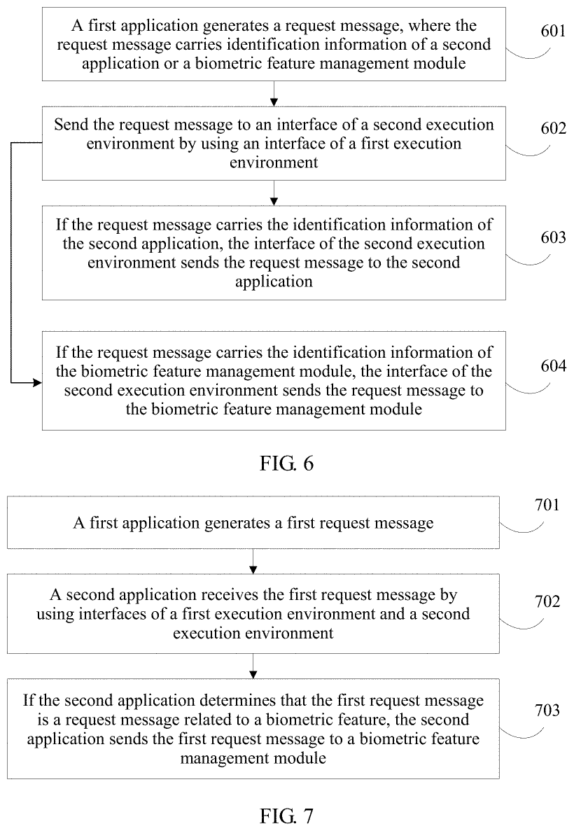

Both FIG. 4 and FIG. 5 are diagrams of fingerprint identification architectures according to embodiments of the present invention. The fingerprint identification architectures in FIG. 4 and FIG. 5 may be used to perform a fingerprint authentication method shown in FIG. 6. A CA in an REE environment establishes a session with a fingerprint management module or a TA in a TEE environment. As shown in FIG. 4, in this embodiment of the present invention, if a transaction requested by a CA is related to a fingerprint, a message sent by the CA by using an REE communication agent and a TEE communication agent is transmitted to an RTA fingerprint management module in the TEE environment. For example, if a transaction requested by a first CA is related to the fingerprint, a message sent by the first CA is transmitted to the RTA fingerprint management module; if a transaction requested by a second CA is related to the fingerprint, a message sent by the second CA is transmitted to the RTA fingerprint management module; and if a transaction requested by a third CA is related to the fingerprint, a message sent by the third CA is transmitted to the RTA fingerprint management module. That is, messages sent by multiple CAs are transmitted to the RTA fingerprint management module when biometric feature authentication is related. In addition, as shown in FIG. 5, in this embodiment of the present invention, a TEE environment is provided with a TA corresponding to a CA. If a transaction requested by the CA is unrelated to a biometric feature, a message sent by the CA by using an REE communication agent and a TEE communication agent is transmitted to the TA corresponding to the CA. A request that is sent by the CA and that is unrelated to the biometric feature may be a text password authentication request, for example, to request to verify whether a number password entered by a user is correct or request to verify whether a letter password entered by a user is correct. For example, if a transaction requested by a CA 1 is unrelated to the biometric feature, a message sent by the CA 1 is transmitted to a TA 1; and if a transaction requested by a CA 2 is unrelated to the biometric feature, a message sent by the CA 2 is transmitted to a TA 2. That is, messages sent by multiple CAs are respectively transmitted to TAs corresponding to the CAs when biometric feature authentication is unrelated; and messages sent by multiple CAs are transmitted to an RTA fingerprint management module when biometric feature authentication is related. Whether a message is transmitted to a TA or transmitted to an RTA fingerprint management module may be determined according to an identifier carried in the message. A TEE communication agent forwards the message to the TA or the RTA fingerprint management module according to the identifier in the message.

Specifically, on one hand, if a service initiated by the CA 1 is related to fingerprint authentication, the CA 1 invokes a TEE Client API in the REE environment, and creates a session with the fingerprint management module in the TEE environment. The CA 1 initiates a command in the session, and the initiated command is transmitted to the fingerprint management module by using the REE communication agent in the REE environment and the TEE communication agent in the TEE environment. The fingerprint management module invokes a fingerprint identification function module (Fingerprint Biometrics), and runs an SE and a sensor on a hardware platform, so as to perform an operation related to fingerprint interaction. When the RTA fingerprint management module completes the operation, and needs to transmit a fingerprint interaction result to the CA 1, the fingerprint management module invokes a TEE Internal API interface, and transmits the interaction result to the CA 1 by using the TEE communication agent in the TEE environment and the TEE Client API in the REE environment, for example, transmits encryption and decryption information, a signature, and the like to the CA 1. Likewise, if a service initiated by the CA 2 is related to fingerprint authentication, the CA 2 invokes the TEE Client API in the REE environment, and creates a session with the fingerprint management module in the TEE environment. The CA 2 initiates a command in the session, and the command is transmitted to the fingerprint management module by using the REE communication agent and the TEE communication agent. The fingerprint management module invokes the fingerprint biometrics, and runs the SE and the sensor on the hardware platform, so as to perform an operation related to fingerprint interaction. After the operation is completed, the fingerprint management module invokes the TEE Internal API interface, and transmits an interaction result to the CA 2 by using the TEE communication agent and the TEE Client API, for example, transmits encryption and decryption information, a signature, and the like to the CA 2. In a possible implementation, when multiple CAs in the REE environment initiate multiple request messages related to fingerprint interaction, UUIDs carried in these request messages are the same and point to the fingerprint management module in the TEE environment. That is, in the embodiments shown in FIG. 4 and FIG. 5, when a biometric feature authentication service is related, for example, a fingerprint authentication service, multiple CAs in the REE environment are corresponding to one fingerprint management module in the TEE environment. Messages that are sent by the multiple CAs and that are related to fingerprint authentication point to the fingerprint management module, and the fingerprint management module performs corresponding processing.

On the other hand, if a service initiated by the CA 1 is unrelated to fingerprint authentication, the CA 1 invokes a TEE Client API in the REE environment, and creates a session with the TA 1 in the TEE environment, where the TA 1 is corresponding to the CA 1. The CA 1 initiates a command in the session, and the initiated command is transmitted to the TA 1 by using the REE communication agent in the REE environment and the TEE communication agent in the TEE environment. The TA 1 invokes a TEE Internal API, performs a corresponding authentication operation, and after authentication is completed, sends an authentication result to the CA 1 in the REE environment by using the TEE communication agent and the REE communication agent. If a service initiated by the CA 2 is unrelated to fingerprint authentication, the CA 2 invokes a TEE Client API in the REE environment, and creates a session with the TA 2 in the TEE environment, where the TA 2 is corresponding to the CA 2. The CA 2 initiates a command in the session, and the initiated command is transmitted to the TA 2 by using the REE communication agent and the TEE communication agent. The TA 2 invokes a TEE Internal API, performs a corresponding authentication operation, and after authentication is completed, sends an authentication result to the CA 2 in the REE environment. In a possible implementation, when a CA in the REE environment initiates request messages unrelated to fingerprint interaction, these request messages carry a UUID of a TA corresponding to the CA, and the request messages are sent to the TA that is corresponding to the CA and that is in the TEE environment. That is, in the embodiments shown in FIG. 4 and FIG. 5, when a biometric feature authentication service is unrelated, for example, a fingerprint authentication service is unrelated, one CA in the REE environment is corresponding to one TA in the TEE environment. A message that is sent by the CA and that is unrelated to fingerprint authentication points to the TA, and the TA corresponding to the CA performs corresponding processing.

Specifically, an Alipay CA runs in Android, an Alipay TA runs in the TEE, and the RTA fingerprint management module runs in the TEE. The RTA fingerprint management module is configured to perform an operation related to fingerprint authentication. The Alipay CA generates an authentication request, and the authentication request carries identification information of the Alipay CA or identification information of the RTA fingerprint management module. If the authentication request is unrelated to a biometric feature, the authentication request carries an identifier of the Alipay CA; or if the authentication request is related to a biometric feature, for example, fingerprint authentication, the authentication request carries an identifier of the RTA fingerprint management module. The authentication request is sent to an interface of the TEE by using an interface of Android, for example, sent to the TEE communication agent by using the REE communication agent. The TEE communication agent determines, according to the identification information, an object to which the authentication request is sent. If the identifier of the Alipay TA is carried, the authentication request is sent to the Alipay TA. The Alipay TA invokes a TEE Internal API for corresponding authentication, and returns an authentication result by using an original path. If the identifier of the RTA fingerprint management module is carried, the authentication request is sent to the RTA fingerprint management module. The RTA fingerprint management module invokes the fingerprint biometrics, and the fingerprint biometrics invokes the SE and the sensor on the hardware platform, so as to perform an operation related to fingerprint interaction, and generate an authentication result. After obtaining the authentication result, the RTA fingerprint management module returns the authentication result by using an original path, that is, the RTA fingerprint management module sends the fingerprint authentication result to the Alipay TA, and the Alipay TA sends the fingerprint authentication result to the Alipay CA by using the TEE communication agent and the REE communication agent. That is, in this embodiment of the present invention, if fingerprint authentication is related, authentication requests sent by multiple CAs in Android carry the identifier of the RTA fingerprint management module to request fingerprint authentication.

Further, when the RTA fingerprint management module performs fingerprint authentication, reference may be made to descriptions related to the type information carried by the CA in the foregoing embodiment. That is, when fingerprint authentication is related, the CA carries type information and a to-be-authenticated fingerprint, for example, the Alipay CA carries payment-type type information and a thumb fingerprint. After obtaining the authentication request, the RTA fingerprint management module invokes hardware on the hardware platform by using the fingerprint biometrics, and determines whether there is a payment-type fingerprint. If there is a payment-type fingerprint, the RTA fingerprint management module traverses payment-type fingerprints, and determines whether there is a fingerprint that matches the thumb fingerprint. If there is a fingerprint that matches the thumb fingerprint, the RTA fingerprint management module determines that fingerprint authentication succeeds; or if there is no fingerprint that is in the payment-type fingerprints and that matches the thumb fingerprint, the RTA fingerprint management module traverses all fingerprints stored in the mobile terminal, and determines whether there is a fingerprint that matches the thumb fingerprint. If there is a fingerprint that matches the thumb fingerprint, the RTA fingerprint management module determines that fingerprint authentication succeeds; or if there is no fingerprint that matches the thumb fingerprint, the RTA fingerprint management module determines that fingerprint authentication fails.

Adaptively, referring to the embodiment shown in FIG. 4 or FIG. 5 and the mobile terminal structure shown in FIG. 1, an embodiment of the present invention further provides a mobile terminal, configured to perform the method shown in FIG. 6. The mobile terminal includes: one or more processors, a memory, multiple application programs, and one or more programs, where the one or more programs are stored in the memory and executed by the one or more processors, the one or more programs include an instruction, and the instruction is used to perform the following operations: running, by a first application, in a first execution environment; running, by a second application, in a second execution environment, where the second application is associated with the first application; running, by a biometric feature management module, in the second execution environment, where the biometric feature management module is configured to perform, in the second execution environment, an operation related to biometric feature authentication; generating, by the first application, a request message, where the request message carries identification information of the second application or the biometric feature management module (601); sending the request message to an interface of the second execution environment by using an interface of the first execution environment (602); and if the request message carries the identification information of the second application, sending, by the interface of the second execution environment, the request message to the second application (603); or if the request message carries the identification information of the biometric feature management module, sending, by the interface of the second execution environment, the request message to the biometric feature management module (604).

Further, in this embodiment of the mobile terminal, the one or more processors execute the instruction to further perform the following operations: generating, by the biometric feature management module, a response message, where the response message is a response made by the biometric feature management module to the request message; sending the response message to the interface of the first execution environment by using the interface of the second execution environment; and sending, by the interface of the first execution environment, the response message to the first application. Further, the request message is used to request to authenticate a biometric feature; and the one or more processors execute the instruction to perform the following operations: the generating, by the biometric feature management module, a response message includes: invoking, by the biometric feature management module by using a biometric feature interface, hardware of the mobile terminal to obtain a to-be-authenticated biometric feature; obtaining, by the hardware of the mobile terminal, a biometric feature stored in the mobile terminal; determining, by the hardware of the mobile terminal, whether the to-be-authenticated biometric feature matches the biometric feature stored in the mobile terminal, and generating an authentication result; and receiving, by the biometric feature management module, the authentication result sent by the hardware of the mobile terminal by using the biometric feature interface, and generating the response message; or further, the request message carries type information of the first application, and the request message is used to request to authenticate a biometric feature; and the one or more processors execute the instruction to perform the following operations: the generating, by the biometric feature management module, a response message includes: invoking, by the biometric feature management module by using a biometric feature interface, hardware of the mobile terminal to obtain a to-be-authenticated biometric feature; obtaining, by the hardware of the mobile terminal, at least one first biometric feature stored in the mobile terminal, where type information of the first biometric feature matches the type information of the first application; and if the hardware of the mobile terminal determines that the to-be-authenticated biometric feature matches the first biometric feature, receiving, by the biometric feature management module, a first authentication result sent by the hardware of the mobile terminal by using the biometric feature interface, and generating the response message. The one or more processors execute the instruction to further perform the following operations: if the hardware of the mobile terminal determines that the to-be-authenticated biometric feature does not match the first biometric feature, traversing, by the hardware of the mobile terminal, all biometric features to attempt to authenticate the to-be-authenticated biometric feature; generating, by the hardware of the mobile terminal, a second authentication result, and sending the second authentication result to the biometric feature interface; and receiving, by the biometric feature management module, the second authentication result sent by the hardware of the mobile terminal by using the biometric feature interface, and generating the response message.

It should be noted that, in the embodiments of the present invention, descriptions such as “first” and “second” are only used to distinguish between described objects, and do not have actual meanings. A portable electronic device, a mobile terminal, and a terminal are equivalent.

Functional modules in the embodiments of the present invention may be integrated into one processing unit module, or each of the modules may exist alone physically, or two or more modules are integrated into one module. The integrated module may be implemented in a form of hardware, or may be implemented in a form of hardware in addition to a software functional unit.

It may be clearly understood by persons skilled in the art that, for the purpose of convenient and brief description, division of the foregoing function modules is taken as an example for illustration. In actual application, the foregoing functions can be allocated to different function modules and implemented according to a requirement, that is, an inner structure of an apparatus is divided into different function modules to implement all or part of the functions described above. For a detailed working process of the apparatus, refer to a corresponding process in the method embodiment. An implementation principle and a technical effect of the apparatus are similar to those of the method embodiment, and a same or corresponding technical feature is not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. An authentication method for a mobile terminal, wherein the method comprises:
running, by a first application, in a first execution environment;
running, by a second application, in a second execution environment, wherein the second application is associated with the first application;
running, by a biometric feature management module, in the second execution environment, wherein the biometric feature management module is configured to perform, in the second execution environment, an operation related to biometric feature authentication;
generating, by the first application, a request message, wherein the request message carries identification information of the second application or the biometric feature management module;
sending the request message to an interface of the second execution environment by using an interface of the first execution environment; and
if the request message carries the identification information of the second application, sending, by the interface of the second execution environment, the request message to the second application; or
if the request message carries the identification information of the biometric feature management module, sending, by the interface of the second execution environment, the request message to the biometric feature management module.

2. The method according to claim 1, wherein the method further comprises:
generating, by the biometric feature management module, a response message, wherein the response message is a response made by the biometric feature management module to the request message;
sending the response message to the interface of the first execution environment by using the interface of the second execution environment; and
sending, by the interface of the first execution environment, the response message to the first application.

3. The method according to claim 2, wherein the request message is used to request to authenticate a biometric feature; and the generating, by the biometric feature management module, a response message comprises:
invoking, by the biometric feature management module and by using a biometric feature interface, hardware of the mobile terminal to obtain a to-be-authenticated biometric feature;
obtaining, by the hardware of the mobile terminal, a biometric feature stored in the mobile terminal;
determining, by the hardware of the mobile terminal, whether the to-be-authenticated biometric feature matches the biometric feature stored in the mobile terminal, and generating an authentication result; and
receiving, by the biometric feature management module, the authentication result sent by the hardware of the mobile terminal and by using the biometric feature interface, and generating the response message.

4. The method according to claim 2, wherein the request message carries type information of the first application, and the request message is used to request to authenticate a biometric feature; and the generating, by the biometric feature management module, a response message comprises:
invoking, by the biometric feature management module and by using a biometric feature interface, hardware of the mobile terminal to obtain a to-be-authenticated biometric feature;
obtaining, by the hardware of the mobile terminal, at least one first biometric feature stored in the mobile terminal, wherein type information of the at least one first biometric feature matches the type information of the first application; and
if the hardware of the mobile terminal determines that the to-be-authenticated biometric feature matches the at least one first biometric feature, receiving, by the biometric feature management module, a first authentication result sent by the hardware of the mobile terminal and by using the biometric feature interface, and generating the response message.

5. The method according to claim 4, wherein the method further comprises:
if the hardware of the mobile terminal determines that the to-be-authenticated biometric feature does not match the at least one first biometric feature, traversing, by the hardware of the mobile terminal, all biometric features to attempt to authenticate the to-be-authenticated biometric feature;
generating, by the hardware of the mobile terminal, a second authentication result, and sending the second authentication result to the biometric feature interface; and
receiving, by the biometric feature management module, the second authentication result sent by the biometric feature interface, and generating the response message.

6. The method according to claim 1, wherein the operation related to biometric feature authentication comprises at least one of a register operation of a biometric feature, a delete operation of a biometric feature, a verify operation of a biometric feature, or a cancel operation of an association relationship between a biometric feature and an application.

7-13. (canceled)

14. A mobile terminal, wherein the mobile terminal comprises one or more processors, a memory, multiple application programs, and one or more programs, wherein the one or more programs are stored in the memory and executed by the one or more processors, wherein the one or more programs comprise an instruction, and wherein the instruction is used to perform the following operations:
running, by a first application, in a first execution environment;
running, by a second application, in a second execution environment, wherein the second application is associated with the first application;
running, by a biometric feature management module, in the second execution environment, wherein the biometric feature management module is configured to perform, in the second execution environment, an operation related to biometric feature authentication;
generating, by the first application, a request message, wherein the request message carries identification information of the second application or the biometric feature management module;
sending the request message to an interface of the second execution environment by using an interface of the first execution environment; and
if the request message carries the identification information of the second application, sending, by the interface of the second execution environment, the request message to the second application; or
if the request message carries the identification information of the biometric feature management module, sending, by the interface of the second execution environment, the request message to the biometric feature management module.

15. The mobile terminal according to claim 14, wherein the one or more processors execute the instruction to further perform the following operations:
generating, by the biometric feature management module, a response message, wherein the response message is a response made by the biometric feature management module to the request message;
sending the response message to the interface of the first execution environment by using the interface of the second execution environment; and
sending, by the interface of the first execution environment, the response message to the first application.

16. The mobile terminal according to claim 15, wherein the request message is used to request to authenticate a biometric feature; and the generating, by the biometric feature management module, a response message comprises:
invoking, by the biometric feature management module and by using a biometric feature interface, hardware of the mobile terminal to obtain a to-be-authenticated biometric feature;
obtaining, by the hardware of the mobile terminal, a biometric feature stored in the mobile terminal;
determining, by the hardware of the mobile terminal, whether the to-be-authenticated biometric feature matches the biometric feature stored in the mobile terminal, and generating an authentication result; and
receiving, by the biometric feature management module, the authentication result sent by the hardware of the mobile terminal and by using the biometric feature interface, and generating the response message.

17. The mobile terminal according to claim 15, wherein the request message carries type information of the first application, and the request message is used to request to authenticate a biometric feature; and the generating, by the biometric feature management module, a response message comprises:
invoking, by the biometric feature management module and by using a biometric feature interface, hardware of the mobile terminal to obtain a to-be-authenticated biometric feature;
obtaining, by the hardware of the mobile terminal, at least one first biometric feature stored in the mobile terminal, wherein type information of the at least one first biometric feature matches the type information of the first application; and
if the hardware of the mobile terminal determines that the to-be-authenticated biometric feature matches the at least one first biometric feature, receiving, by the biometric feature management module, a first authentication result sent by the hardware of the mobile terminal and by using the biometric feature interface, and generating the response message.

18. The mobile terminal according to claim 17, wherein the one or more processors execute the instruction to further perform the following operations:
if the hardware of the mobile terminal determines that the to-be-authenticated biometric feature does not match the at least one first biometric feature, traversing, by the hardware of the mobile terminal, all biometric features to attempt to authenticate the to-be-authenticated biometric feature;
generating, by the hardware of the mobile terminal, a second authentication result, and sending the second authentication result to the biometric feature interface; and
receiving, by the biometric feature management module, the second authentication result sent by the biometric feature interface, and generating the response message.

19. The mobile terminal according to claim 14, wherein the operation related to biometric feature authentication comprises at least one of a register operation of a biometric feature, a delete operation of a biometric feature, a verify operation of a biometric operation, or a cancel operation of an association relationship between a biometric feature and an application.

20. A mobile terminal, wherein the mobile terminal comprises one or more processors, a memory, multiple application programs, and one or more programs, wherein the one or more programs are stored in the memory and executed by the one or more processors, wherein the one or more programs comprise an instruction, and wherein the instruction is used to perform the following operations:
running, by a first application, in a first execution environment;
running, by a second application, in a second execution environment, wherein the second application is associated with the first application;
running, by a biometric feature management module, in the second execution environment;
generating, by the first application, a first request message;
receiving, by the second application, the first request message by using interfaces of the first execution environment and the second execution environment; and
if the second application determines that the first request message is a request message related to a biometric feature, sending, by the second application, the first request message to the biometric feature management module.

21. The mobile terminal according to claim 20, wherein the one or more processors execute the instruction to further perform the following operations:
running, by a third application, in the first execution environment;
running, by a fourth application, in the second execution environment, wherein the fourth application is associated with the third application;
generating, by the third application, a second request message;
receiving, by the fourth application, the second request message by using the interfaces of the first execution environment and the second execution environment; and
if the fourth application determines that the second request message is a request message related to a second biometric feature, sending, by the fourth application, the second request message to the biometric feature management module.

22. The mobile terminal according to claim 20, wherein the one or more processors execute the instruction to further perform the following operations:
generating, by the biometric feature management module, a first response message, wherein the first response message is a response made by the biometric feature management module to the first request message;
receiving, by the second application, the first response message sent by the biometric feature management module; and
receiving, by the first application, the first response message by using the interfaces of the first execution environment and the second execution environment.

23. The mobile terminal according to claim 22, wherein the first request message is used to request to authenticate a biometric feature; and the generating, by the biometric feature management module, a first response message comprises:
invoking, by the biometric feature management module and by using a biometric feature interface, hardware of the mobile terminal to obtain a to-be-authenticated biometric feature;
obtaining, by the hardware of the mobile terminal, a biometric feature stored in the mobile terminal;
determining, by the hardware of the mobile terminal, whether the to-be-authenticated biometric feature matches the biometric feature stored in the mobile terminal, and generating an authentication result; and
receiving, by the biometric feature management module, the authentication result sent by the hardware of the mobile terminal and by using the biometric feature interface, and generating the first response message.

24. The mobile terminal according to claim 22, wherein the first request message carries type information of the first application, and the request message is used to request to authenticate a biometric feature; and the generating, by the biometric feature management module, a first response message comprises:
invoking, by the biometric feature management module and by using a biometric feature interface, hardware of the mobile terminal to obtain a to-be-authenticated biometric feature;
obtaining, by the hardware of the mobile terminal, at least one first biometric feature stored in the mobile terminal, wherein type information of the at least one first biometric feature matches the type information of the first application; and
if the hardware of the mobile terminal determines that the to-be-authenticated biometric feature matches the at least one first biometric feature, receiving, by the biometric feature management module, a first authentication result sent by the hardware of the mobile terminal and by using the biometric feature interface, and generating the first response message.

25. The mobile terminal according to claim 24, wherein the one or more processors execute the instruction to further perform the following operations:
if the hardware of the mobile terminal determines that the to-be-authenticated biometric feature does not match the at least one first biometric feature, traversing, by the hardware of the mobile terminal, all biometric features to attempt to authenticate the to-be-authenticated biometric feature;
generating, by the hardware of the mobile terminal, a second authentication result, and sending the second authentication result to the biometric feature interface; and
receiving, by the biometric feature management module, the second authentication result sent by the biometric feature interface, and generating the first response message.

26. The mobile terminal according to claim 20, wherein the operation related to biometric feature authentication comprises at least one of a register operation of a biometric feature, a delete operation of a biometric feature, a verify operation of a biometric operation, or a cancel operation of an association relationship between a biometric feature and an application.
